(19) United States
(12) Patent Application Publication
(10) Pub. No.: US 2005/0271890 A1
(43) Pub. Date: Dec. 8, 2005

(54) Machine tool with a tool shank and a cutting head

(76) Inventor: Michael Koecher, Ludwigsburg (DE)

Correspondence Address: FLYNN THIEL BOUTELL & TANIS, P.C., 2026 RAMBLING ROAD, KALAMAZOO, MI, 49008-1631, US

(21) Appl. No.: 10/522,399

(22) PCT Filed: Jul. 23, 2003
(86) PCT No.: PCT/EP03/08031

§ 371 Date: Jan. 21, 2005

(30) Foreign Application Priority Data
Jul. 23, 2002 (DE) 102 33 530.3

(51) Int. Cl. B32B 15/00

(52) U.S. Cl. 428/615; 228/249

(57) ABSTRACT

The invention relates to a machine tool with a tool shank and a cutting head made from different materials, which are joined to each other on opposite joint surfaces in a positive material fit by means of a joint layer made of a ductile solder material. According to the invention, in order to obtain a solder connection which is substantially stress-free, powder particles made of a temperature-resistant material with a thermal expansion coefficient which is lower than the solder material are embedded-into the joint layer and the density of the powder particles varies along the entire thickness of the joint layer.

The invention relates to a cutting tool having a tool shank and a cutting head made of different materials which are integrally connected to one another via a joining layer made of ductile brazing material at joining surfaces facing one another. Furthermore, the invention relates to a method of producing such a cutting tool and to a brazing disk suitable for producing such a cutting tool.

In the production of boring bars, it is known to produce the tool shank and cutting head separately from different materials, for example by machining or by non-cutting shaping, and to braze them to one another at joining surfaces facing one another (DE-A-198 56 986). A considerable problem with the brazed connection to be produced consists in the fact that the materials to be connected have different coefficients of thermal expansion. This means that stresses may occur in the region of the brazed connection during the cooling process, and these stresses may reduce the loading capacity of the tool and lead to crack formation.

The object of the invention is therefore to improve the known cutting tools of the type specified at the beginning to the effect that the internal stresses occurring in the joining region during the cooling after the brazing operation can be reduced or eliminated.

To achieve this object, the combinations of features specified in patent claims 1, 18 and 25 are proposed. Advantageous configurations and developments of the invention follow from the dependent claims.

The solution according to the invention is primarily based on the idea that the joining layer, over its layer thickness, has a coefficient of thermal expansion which is reduced compared with the brazing material used, with the aim of obtaining in the joining layer, on the shank side and the head side, coefficients of thermal expansion which are brought more into line with the adjacent materials. In order to achieve this, it is proposed according to the invention that powder particles made of a temperature-resistant material having a lower coefficient of thermal expansion than the brazing material be embedded in the joining layer. A variable coefficient of thermal expansion can be achieved by the density of the powder particles varying over the thickness of the joining layer.

A preferred configuration of the invention provides for the tool shank to be made of steel, preferably of tool steel, whereas the cutting head is made of a material of the group comprising cemented carbide, cermet, ceramic, PCD or boron nitride. The joining layer expediently contains a brazing material of the group comprising copper, silver, cobalt or their alloys, whereas the powder particles embedded in the brazing material of the joining layer are made of a material of the group comprising tungsten, molybdenum, iron, cobalt, nickel or their carbides. The thickness of the joining layer should be a multiple of the diameter of the powder particles and should preferably correspond to 10 to 1000 times the diameter of the powder particles. The thickness of the joining layer itself is expediently 0.2 to 1 mm.

For the above combination of features, it is advantageous if the density of the powder particles on the side of the cutting head is greater than on the side of the tool shank.

The joining surfaces, facing one another, of the cutting head and the tool shank are preferably designed as plane surfaces parallel to one another. However, it has been found that, in order to reduce joining stresses, it may be advantageous if the joining surfaces, facing one another, of the cutting head and the tool shank are preferably curved so as to be complementary to one another. It has proved to be especially advantageous if the joining surface of the cutting head is convexly curved and if the joining surface of the tool shank is concavely curved. In this way, the stresses which occur in the joining layer between cemented carbide and brazing filler, and which could lead to crack formation in the case of plane joining surfaces parallel to one another, can be reduced. As an alternative thereto, the joining surfaces may also have structures in the form of grooves, humps, depressions, prominences. In the joined state, such structures result in positive locking and mechanical regions which lead to a stress reduction and to an improved torque transmission.

A further advantageous configuration of the invention provides for the tool shank to have at least one preferably helically wound flute, which passes through the joining layer in the direction of the tool head. Furthermore, it is proposed according to the invention that the tool shank have at least one preferably helically wound functional passage, which passes through the joining layer in the direction of the tool head. The functional passage is mainly intended to direct a cooling lubricant through the tool shank to the cutting edges of the cutting head. For other applications, it is in principle also possible for the density of the powder particles to vary over the radius of the joining layer. This is advantageous in particular if the brazing disk contains inhomogeneities due to the design, for example a non-melting core as centering means.

According to the invention, in the production of the cutting tool, a preformed tool shank and a cutting head preferably preformed as a blank are integrally connected to one another by fusing and subsequently cooling a brazing filler in the region of a joining gap while forming a joining layer. In this case, the invention provides for the brazing filler in the form of at least one disk made of brazing material containing embedded temperature-resistant powder particles, preferably with a variable density over the disk thickness, to be inserted into the joining gap. In this case, it is possible in principle for the brazing disk to be fixed beforehand to one of the joining members, for example for it to be sintered on. The variation in the density profile in the joining layer can be achieved by a plurality of brazing disks having a different particle density being inserted into the joining gap and being fused to one another there.

The method sequence during the production of the brazed connection according to the invention expediently has the following steps:
a) the joining members consisting of the cutting head and the tool shank are heated at least to the melting temperature of the brazing filler used;
b) the at least one brazing disk is inserted into a joining gap between the joining members before, during or after the heating;
c) after the joining temperature is reached, the contact surfaces, facing one another, of the joining members are wetted with fused brazing material;
d) after that, the joining members are cooled preferably to room temperature while forming a composite part;
e) the composite part is then machined preferably at room temperature and is brought to the same diameter in the joining region, for example by grinding;
f) the composite part prepared in this way is heated again to a coating temperature below the joining temperature and held for a time at this temperature and in the process is tempered and preferably coated with a coating material;
g) after that, the composite part is cooled to room temperature while forming the finished part.

The axial density profile of the powder particles in the brazing material is selected in such a way that an essentially stress-free joining zone is formed in the finished part. The tool shank preferably made of a surface-carburized case-hardened steel is hardened during the quenching of the joining members and is annealed and stress-relieved during the subsequent coating process. The brazing disk, in the solid state before the heating of the joining members, is preferably connected to one of the joining members, preferably slipped onto or sintered into place on said joining member.

According to the invention, the brazing disk used for producing the brazed joint is made of a ductile brazing material in which powder particles made of a temperature-resistant material having a lower coefficient of thermal expansion than the brazing material are embedded. The density of the powder particles advantageously varies over the disk thickness, it being possible for the density variation to be produced by a plurality of brazing disks having different particle density. In certain applications, it is also possible to use brazing disks whose particle density varies over the disk radius.

The brazing disk expediently contains a brazing material of the group comprising copper, silver, cobalt or their alloys, whereas the powder particles embedded in the brazing material are made of a material of the group comprising tungsten, molybdenum, iron, cobalt, nickel or their carbides.

According to a further preferred configuration of the invention, the brazing disk has a convex marginal contour which is adapted to the contact points of the joining members and which is interrupted by at least one concave marginal recess for a flute to pass through. Two concave marginal recesses arranged on sides opposite one another are advantageously provided. In addition, the brazing disks may be provided with at least one hole which is in alignment with a functional passage in the joining members. For the connection of joining members having contact surfaces which are not flat, the brazing disk may also be designed as a three-dimensional shaped piece having a corresponding outer contour and, if need be, having transverse passages or apertures.

The invention is explained in more detail below with reference to an exemplary embodiment shown schematically in the drawing, in which:

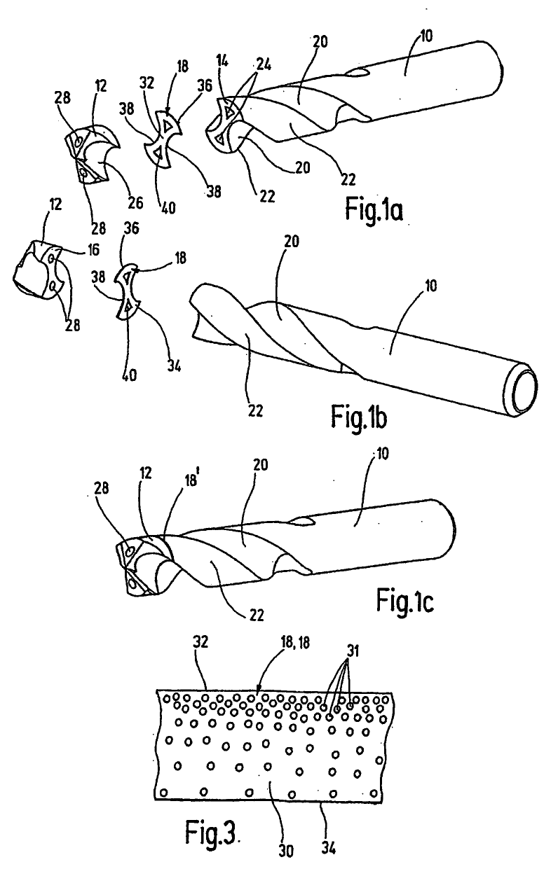

FIGS. 1a and 1b show parts of a drilling tool in two different diagrammatic exploded illustrations;

FIG. 1c shows a diagrammatic illustration of the drilling tool in the finished state;

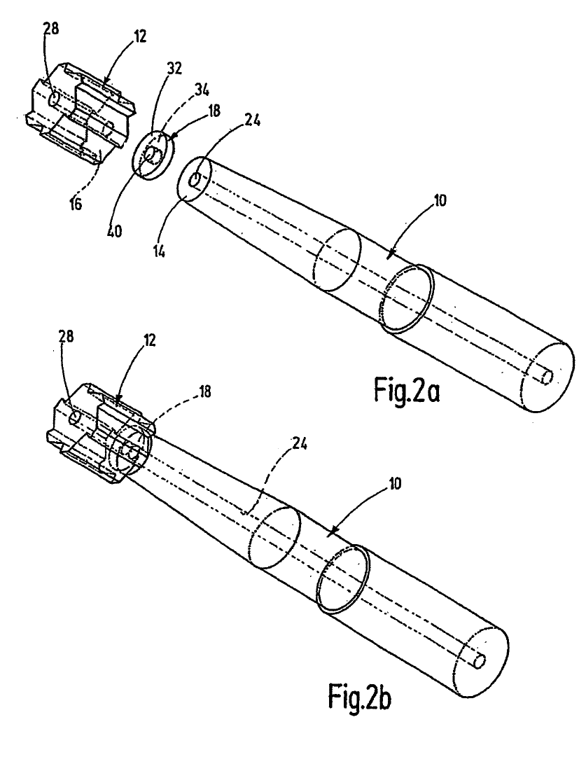

FIGS. 2a and b shows diagrammatic illustrations of a reaming tool in exploded illustration and in the finished state;

FIG. 3 shows a cutaway section through the brazing disk of the tool according to FIGS. 1 and 2 in an enlarged illustration;

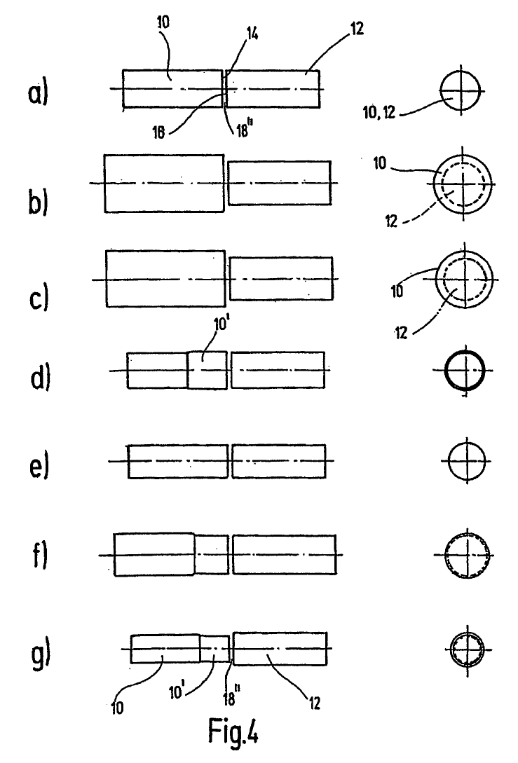

FIGS. 4a to g show a scheme for illustrating the thermal expansion of the joining members of the cutting tool in various method steps during the brazing and coating operation;

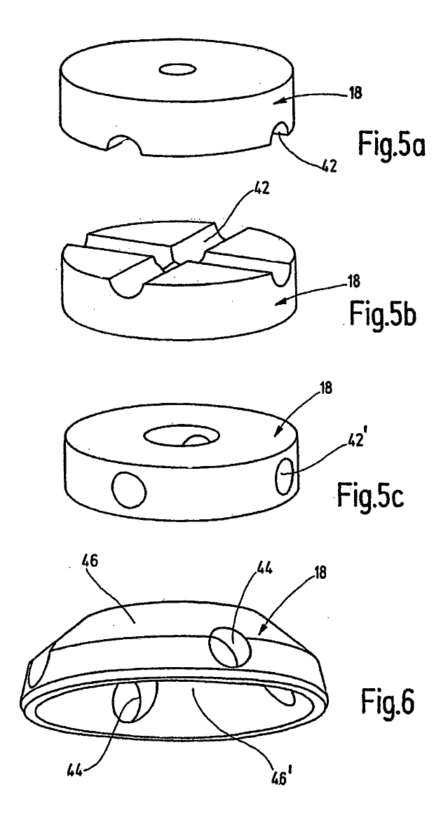

FIGS. 5a and b show a modified exemplary embodiment of two brazing disks, complementing one another, before the brazing operation;

FIG. 5c shows the two brazing disks connected to one another after the brazing operation;

FIG. 6 shows a diagrammatic illustration of a brazing disk designed as a shaped part;

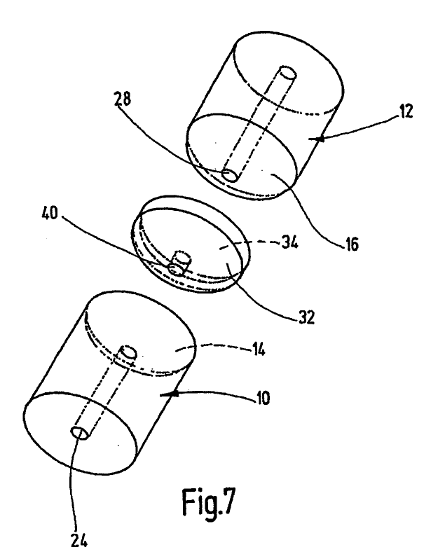

FIG. 7 shows a schematic diagrammatic exploded illustration of the parts of a cutting tool having curved joining surfaces.

The cutting tools shown in FIGS. 1 and 2 essentially comprise a tool shank 10 and a cutting head 12 which are integrally connected (brazed) to one another at their joining surfaces 14, 16 facing one another by means of a brazing disk 18 made of ductile material. The exemplary embodiment shown in FIGS. 1a to c is designed as a drilling tool, whereas the exemplary embodiment according to FIGS. 2a and b is designed as a reaming tool.

In the case of FIGS. 1a to c, the tool shank 10 has two flutes 20, which are defined at their flanks by two helically curved lands 22. Furthermore, provided in the tool shank are two functional passages 24 of triangular cross section which are helically curved with the same pitch as the ribs 22 and extend along the ribs 22 of the tool shank 10. The tool shank 10, which is preferably made of carburized case-hardened steel, forms a semifinished product whose flutes 20 and functional passages 24 have been shaped into a tubular blank by rotary swaging (cf. DE-A-198 56 986). The blank is expediently made of a case-hardened steel whose phase transformation point lies within a range of between 480 and 650° C. A case-hardened steel having a carbon content of less than 2%, preferably a 16MnCr5 steel, is advantageously used for this purpose. On account of its ductility, this material can be worked without cracking in the swaging process. The material is then surface-hardened either only on the outside or on the outside and inside by carburizing. As a result, a defined hardness profile over the wall cross section is obtained, so that in the hardened state the drill body has hard surface regions and tough inner regions which ensure that any cracks which arise in the hardened region do not continue into the interior of the drill. As a result, the risk of fracture is reduced and the loading capacity of the drill is increased. Alternatively, the drill may also be hardened by nitriding. The high phase transformation point is also advantageous for the subsequent brazing process, since during the cooling the phase transformation is associated with an increase in volume which reduces any stresses at the joint with the brazing filler, so that crack formation at the joint is avoided. The relatively low proportion of chrome in the case-hardened steel is decisive for these properties.

The cutting head 12 is formed as a shaped part preferably from cemented carbide, cermet, ceramic or polycrystalline diamond. It also contains flutes 26 and functional passages 28, which communicate with the flutes 20 and the functional passages 24, respectively, of the tool shank 10.

In the reamer according to FIG. 2, the tool shank 10 is integrally connected (brazed) to a cutting head 12, designed as a reaming head, by means of a brazing disk 18. The functional passages 24, 28 are arranged there centrally in the tool shank 10 and in the cutting head 12.

Since the tool shank 10 and the cutting head 12 are made of different materials, they have different coefficients of thermal expansion. During the brazing operation, internal stresses may occur in the joining layer 18′ and in the boundary region of the joining surfaces 14, 16, and these stresses may reduce the loading capacity of the tool and lead to crack formation. In order to avoid this, the brazing disk is made of a ductile brazing material 30 made of copper or silver in which powder particles 31 made of a temperature-resistant material, that is to say a material which does not melt at joining temperature, having a lower coefficient of thermal expansion than the brazing material 30 are embedded. The powder particles 31 are completely enveloped by the brazing material 30 and are wetted with the brazing material during the fusion. They have the task of adapting the coefficients of thermal expansion of the brazing material to the two joining members (tool shank 10 and cutting head 12). In this case, the density of the powder particles is variable over the thickness of the brazing disk 18 or the joining layer 18′. In the exemplary embodiment shown, the density of the powder particles is higher on the side 32 of the cutting head 12 than on the side 34 of the tool shank 10. The powder particles embedded in the brazing material can be made of a material of the group comprising tungsten, molybdenum, iron, cobalt, nickel or their carbides.

In the exemplary embodiment shown in FIGS. 1 to c, the brazing disk 18 has, in adaptation to the contour of the joining surfaces 14, 16, a convex outer contour 36 which is interrupted by two concave marginal recesses 38. The marginal recesses correspond to the flutes 20 in the adjacent joining members 10, 12. Furthermore, the brazing disk 18 there contains two apertures 40 which are triangular in outline and which correspond in their arrangement and shape to the functional passages 24 in the tool shank 10. Arranged in the brazing disk 18 in the exemplary embodiment according to FIG. 2 is a central aperture 14, via which the functional passages 24, 28 in the tool shank 10 and in the reaming head 12 communicate after the joining process.

During the brazing operation, the brazing disk 18 is inserted between the joining surfaces 14, 16 of the tool shank 10 and of the cutting head 12. The relevant parts are then heated to melting temperature of the brazing material and are connected to one another while the joining layer 18′ is formed.

The changes in size which occur during the brazing operation and during a subsequent coating operation on account of the different thermal expansion in the two joining members 10, 12 are shown schematically in the sequence scheme according to FIG. 4. There, the tool shank 10 made of steel and the cutting head 12 made of cemented carbide are shown on the left and the right, respectively, in a side view and are shown on the far right in a plan view from the tool shank. For the sake of simplicity, the joining zone 18″ between the two joining members 10, 12 is indicated by a gap 18″. This gap 18″ contains the brazing disk 18 (FIG. 4a) or the joining layer 18′ (FIGS. 4b to g). The changes in size (length and diameter) of the joining members are shown exaggerated in FIG. 4 for clarification.

At the initial point in FIG. 4a, the joining members 10, 12 are shown as cylindrical components of the same size. During the heating to joining temperature of 1100° C. (copper brazing filler), the cylinders expand differently on account of the different thermal expansion. The component 10 (steel) expands more than the component 12 (cemented carbide). Since there is still no connection between the components, no internal stresses occur in the joining region in the course of the heating. After the joining temperature at 1100° C. is reached (FIG. 4c), the brazing material becomes molten. At this temperature, the enlarged cylinders form an integral connection which is still free of stress. During the cooling to room temperature (FIG. 4d), the brazing filler solidifies, while a reduction in diameter occurs in the components 10 and 12. In addition, a new hardness zone 10′ which is associated with an increased lattice stress and an increase in volume forms in the steel within the region of rapid cooling. In the cooled state, the component is finish-machined (FIG. 4e). In the process, the components are ground to the same diameter. For the tool and the cutting material, it is essential that the parts, after being connected, are coated with a material of high hardness, such as titanium, titanium nitride, boron nitride or aluminum nitride. To this end, the tool is heated to a coating temperature of about 500° C. (FIG. 4f). The coating material is vapor-deposited on the tool in a vacuum at the coating temperature. In the process, the temperature is kept constant for a certain period. At the increased temperature, a structural change occurs in the steel, on account of which the hardening in the new hardness zone 10′ is neutralized. At the same time, this results in a reduction in volume in the steel (FIG. 4g). During the subsequent cooling, this leads to the component 10 in the region of the zone 10′ being given a smaller outside diameter than immediately after the brazing process. In the process, there is the risk of internal stresses occurring in the joining region. According to the invention, these stresses are avoided by the variation, indicated schematically in FIG. 3, in the powder density in the joining layer 18′. With regard to its ductility and thermal expansion, the brazing disk 18 must therefore be designed in such a way that, in the coated work state (FIG. 4g), there must largely be freedom from stress in the joining region 18′ and in the adjacent regions of the joining surfaces 14, 16. In the intermediate states, the brazing filler must absorb the stresses possibly occurring on account of its ductility and the locally varying thermal expansion.

As shown in FIGS. 5a to c and 6, the brazing disk 18 may also be formed as a shaped part in which passage-forming recesses 42 or holes 44 are formed. Provided in the case of FIGS. 5a and b are two complementary brazing disks 18 whose recesses 42 open at the margin complement one another to form closed radial passages 42′ after the brazing operation.

In the case of FIG. 6, the brazing disk 18 is designed as a three-dimensional shaped piece which has a conical centering section 46 and oblique holes 44. To this end, the joining surfaces 14, 16 of the joining members 10, 12 must be adapted to the adjacent external and internal cones 44, 46′ of the brazing disk 18. In this case, in addition to the centering function, the conical centering section 46, 46′ also has an orientation function, which ensures that the brazing disk with its variable thermal expansion is inserted with the correct orientation.

In the exemplary embodiments shown in FIGS. 1 and 2, the joining surfaces 14, 16 of the joining members 10, 12 are designed as plane surfaces parallel to one another. Tests have shown that, in particular in a cemented carbide body as joining member, cracks which originate from joining stresses may occur. These inadmissible joining stresses can be reduced or avoided by the joining surfaces facing one another being curved concavely and/or convexly. In the case of the exemplary embodiment according to FIG. 7, the joining surface 16 of the cutting head, preferably made of cemented carbide, is curved convexly and the joining surface 14 of the tool shank 10 is curved concavely, the brazing disk 18 having a curvature complementary thereto on its sides 32, 34 facing the joining members. For clarification, the relevant curvatures in FIG. 7 are shown exaggerated.

In summary, the following may be emphasized: the invention relates to a cutting tool having a tool shank 10 and a cutting head 12 made of different materials which are integrally connected to one another via a joining layer 18′ made of ductile brazing material at joining surfaces 14, 16 facing one another. In order to obtain a largely stress-free brazed connection, it is proposed according to the invention that powder particles 31 made of a temperature-resistant material having a lower coefficient of thermal expansion than the brazing material 30 be embedded in the joining layer 18′, the density of the powder particles 31 varying over the thickness of the joining layer 18′.

1. A cutting tool having a tool shank (10) and a cutting head (12) made of different materials which are integrally connected to one another via a joining layer (18′) made of ductile brazing material at joining surfaces (14, 16) facing one another, powder particles (31) made of a temperature-resistant material having a lower coefficient of thermal expansion than the brazing material (30) being embedded in the joining layer (18′), characterized in that the joining layer (18′) has a different coefficient of thermal expansion over its layer thickness, the coefficient of thermal expansion being lower on the side (32) of the cutting head (12) than on the side (34) of the tool shank (10).

2. The cutting tool as claimed in claim 1, characterized in that the density of the powder particles (31) varies over the thickness of the joining layer (18′).

3. The cutting tool as claimed in claim 1, characterized in that the density of the powder particles (31) within the joining layer (18′) is higher on the side (32) of the cutting head (12) than on the side (34) of the tool shank (10).

4. The cutting tool as claimed in claim 1, characterized in that the tool shank (10) is made of steel, preferably of tool steel.

5. The cutting tool as claimed in claim 4, characterized in that the tool shank is made of a case-hardened steel having a phase transformation point within a range of 480 to 650° C.

6. The cutting tool as claimed in claim 5, characterized in that the tool shank is made of a case-hardened steel having a chrome content of less than 2%.

7. The cutting tool as claimed in claim 5, characterized in that the tool shank is made of a 16MnCr5 steel.

8. The cutting tool as claimed in claim 5, characterized in that the case-hardened steel is carburized or nitrided at least on the outer surface of the tool shank.

9. The cutting tool as claimed in claim 1, characterized in that the cutting head is made of a material of the group comprising cemented carbide, cermet, ceramic or PCD.

10. The cutting tool as claimed in claim 1, characterized in that the joining surfaces (14, 16), facing one another, of the tool shank (10) and the cutting head (12) are preferably curved so as to be complementary to one another.

11. The cutting tool as claimed in claim 1, characterized in that the joining surface (14) of the cutting head (12) is convexly curved.

12. The cutting tool as claimed in claim 1, characterized in that the joining surface (14) of the tool shank (10) is concavely curved.

13. The cutting tool as claimed in claim 1, characterized in that the tool shank (10) has at least one preferably helically wound flute (26), which passes through the joining layer (18′) in the direction of the cutting head (12).

14. The cutting tool as claimed in claim 1, characterized in that the tool shank (10) has at least one preferably helically wound functional passage (28), which passes through the joining layer (18′) in the direction of the cutting head (12).

15. The cutting tool as claimed in claim 1, characterized in that the joining layer (18′) contains a brazing material of the group comprising copper, silver, cobalt or their alloys.

16. The cutting tool as claimed in claim 1, characterized in that the powder particles (31) embedded in the brazing material (30) of the joining layer (18′) are made of a material of the group comprising tungsten, molybdenum, iron, cobalt, nickel or their carbides.

17. The cutting tool as claimed in claim 1, characterized in that the thickness of the joining layer (18′) corresponds to 10 to 1000 times the diameter of the powder particles (31).

18. The cutting tool as claimed in claim 1, characterized in that the thickness of the joining layer (18′) is 0.1 to 2 mm.

19. A method of producing a cutting tool in which a preformed tool shank (10) and a cutting head (12) preferably preformed as a blank are integrally connected to one another by fusing and subsequently cooling a brazing filler (18) in the region of a joining gap while forming a joining layer (18′), characterized in that the brazing filler in the form of at least two brazing disks (18) made of brazing material (30) containing embedded temperature-resistant powder particles (31) and having a different particle density is inserted into the joining gap and in that the brazing disks are fused to one another there.

20. The method as claimed in claim 19, characterized by the following method steps:
a) the joining members consisting of tool shank (10) and cutting head (12) are heated to joining temperature;
b) the at least two brazing disks (18) are inserted into a joining gap between the joining members (10, 12) before, during or after the heating;
c) after the joining temperature is reached, the joining surfaces (14, 16), facing one another, of the joining members (10, 12) are wetted with fused brazing material (30);
d) after that, the joining members are cooled to room temperature while forming a composite part;
e) the composite part is then machined at room temperature and is brought to the same diameter in the joining region, for example by grinding;
f) the composite part prepared in this way is heated again to a coating temperature below the joining temperature and held for a time at this temperature and in the process is preferably coated with a coating material;
g) after that, the composite part is cooled to room temperature while forming the finished part.

21. The method as claimed in claim 19, characterized in that the axial density profile of the powder particles (31) in the brazing material is selected in such a way that an essentially stress-free joining zone is formed in the finished part.

22. The method as claimed in claim 19, characterized in that the structure of the tool shank (10) made of carbon steel or a surface-carburized case-hardened steel is hardened during the rapid cooling of the joining members and is annealed and stress-relieved during the subsequent tempering and/or coating process.

23. The method as claimed in claim 19, characterized in that the brazing disks (18), in the solid state before the heating of the joining members (10, 12), are connected to one of the joining members, preferably slipped onto or sintered in place on said joining member.

24. A brazing disk made of a ductile brazing material in which powder particles made of a temperature-resistant material having a lower coefficient of thermal expansion than the brazing material are embedded, characterized in that the density of the powder particles (31) varies over the disk thickness.

25. The brazing disk as claimed in claim 24, characterized in that the density of the powder particles varies over the disk radius.

26. The brazing disk as claimed in claim 24, characterized in that it is designed as a three-dimensional shaped piece which has a functional structure formed by holes (42′, 44), recesses (42) or grooves.

27. A brazing disk made of a ductile brazing material in which powder particles made of a temperature-resistant material having a lower coefficient of thermal expansion than the brazing material are embedded, characterized in that it is designed as a three-dimensional shaped piece which has a functional structure formed by holes (42′, 44), recesses (42) or grooves.

28. The brazing disk as claimed in claim 24, characterized in that it contains a brazing material of the group comprising copper, silver, cobalt and their alloys.

29. The brazing disk as claimed in claim 24, characterized in that the powder particles (31) embedded in the brazing material (30) are made of a material of the group comprising tungsten, molybdenum, iron, cobalt, nickel or their carbides.

30. The brazing disk as claimed in claim 24, characterized in that it has a convex contour (36) which is interrupted by at least one concave marginal recess (38).

31. The brazing disk as claimed in claim 30, characterized in that two concave marginal recesses (38) arranged on sides opposite one another are provided.

32. The brazing disk as claimed in claim 24, characterized in that it has at least one central hole (44).

33. The brazing disk as claimed in claim 24, characterized in that it has two plane joining surfaces (32, 34) parallel to one another.

34. The brazing disk as claimed in claim 24, characterized in that its joining surfaces (32, 34) facing away from one another are convexly and/or concavely curved.

35. The brazing disk as claimed in claim 24, characterized in that its joining surfaces (32, 34) have a surface structure formed from prominences and/or depressions.
